(19) United States
(12) Patent Application Publication
(10) Pub. No.: US 2003/0015240 A1
(43) Pub. Date: Jan. 23, 2003

(54) Poppet valve

(76) Inventors: Donald R. Nelson, Worcester, MA (US); Andre J. Gaudet, Gardner, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/911,368

(22) Filed: Jul. 23, 2001

(51) Int. Cl. F16K 15/00

(52) U.S. Cl. 137/541

(57) ABSTRACT

A poppet valve is designed in a manner that results in relatively low failure rates and/or operates with relatively little or no degradation in performance. The poppet valve may include one or more features, each independently or in combination, contributing to such high service life and/or performance. The poppet valve includes a body, a poppet, and a spring. The poppet valve may also include an interface between the poppet and the spring to permit relative rotation between the spring and the poppet. The poppet valve may also include a limit stop to prevent over-stressing the spring. The body may include one or more tapered walls to reduce interference with the spring. The spring may also be tapered. The poppet may include one or more tapered elements.

### BACKGROUND OF THE INVENTION

1. Field of the Invention

The present invention relates to valves and, more particularly, to poppet valves.

2. Related Art

Poppet valves, also known as check valves, are employed in various process-related applications and in various devices where it is desirable to selectively allow media to pass therethrough in one direction while preventing or reducing reverse flow. In some instances, poppet valves may operate under conditions having adverse effects on the valve in general, and on specific valve components in particular, which may lead to poor valve performance or complete valve failure. Also, some poppet valves may lack robustness, resulting in premature valve failure.

### SUMMARY OF THE INVENTION

Accordingly, a simple, robust, cost-effective poppet valve is provided, which is designed in a manner that may result in relatively low failure rates with relatively little or no degradation in performance under various operating conditions. The poppet valve may include one or more features, each independently or in combination, contributing to a relatively high service life and/or high performance characteristics.

In one embodiment, a poppet valve includes a body and a poppet having an axis and being disposed within the body. The poppet is adapted to move axially between a closed position and an open position. A spring cooperates with the poppet to bias the poppet toward the closed position. The poppet valve also includes an interface element disposed between the poppet and the spring. The interface element facilitates rotation between the poppet and the spring about the axis of the poppet.

In another embodiment, a poppet valve includes a body and a poppet having an axis and being disposed within the body. The poppet is adapted to move axially between a closed position and an open position, thereby defining a stroke. A spring, having a fully compressed length, cooperates with the poppet to bias the poppet toward the closed position. The poppet valve also includes an abutment cooperating with the poppet to limit the stroke of the poppet. Accordingly, a resulting compressed length of the spring when the poppet is in a fully open position is greater than the fully compressed length of the spring.

In another embodiment, a poppet valve includes a body having an inner wall defining a cavity and a poppet having an axis and being disposed within the cavity of the body. The poppet is adapted to move axially between a closed position and an open position. A spring is disposed within the cavity of the body and cooperates with the poppet to bias the poppet toward the closed position. At least a portion of the wall is constructed and arranged to allow movement of the spring without substantial interference between the spring and the portion of the inner wall of the body.

In another embodiment, a poppet valve includes a body defining an upstream end and a downstream end and a poppet disposed within the body. The poppet is adapted to move between a closed position and an open position. The poppet includes at least one leg longitudinally extending between the upstream and downstream ends of the body. The leg has a cross-sectional area that changes along the longitudinal extent of the leg.

In another embodiment, a poppet valve includes a body defining an upstream end and a downstream end. The body has an inner wall defining a cavity. A poppet, having an axis, is disposed within the cavity of the body. The poppet is adapted to move axially between a closed position and an open position, thereby defining a stroke. The poppet includes at least one leg longitudinally extending between the upstream and downstream ends of the body. The leg has a cross-sectional area that changes along the longitudinal extent of the leg. A spring, having a fully compressed length, is disposed within the cavity of the body and cooperates with the poppet to bias the poppet toward the closed position. At least a portion of the inner wall of the body is constructed and arranged to allow movement of the spring without substantial interference between the spring and the portion of the inner wall. The valve also includes a ring disposed on the poppet that cooperates with the spring. The ring facilitates rotation between the poppet and the spring about the axis of the poppet. The valve also includes an abutment engaging with the ring to limit the stroke of the poppet such that a resulting compressed length of the spring when the poppet is in a fully open position is greater than the fully compressed length of the spring.

Various embodiments of the present invention provide certain advantages and overcome certain drawbacks of prior poppet valves. Embodiments of the invention may not share the same advantages, and those that do may not share them under all circumstances. This being said, the present invention provides numerous advantages including the noted advantage of increased service life and/or high performance characteristics.

Further features and advantages of the present invention, as well as the structure of various embodiments, are described in detail below with reference to the accompanying drawings.

### BRIEF DESCRIPTION OF THE DRAWINGS

Various embodiments of the invention will now be described, by way of example, with reference to the accompanying drawings, in which:

FIG. 1 is a cross-sectional side view of a poppet valve, with an open position shown in solid lines and a closed position shown in phantom lines;

FIG. 2 is a cross-sectional side view of the poppet valve taken along line 2-2 of FIG. 1, with the poppet valve shown in the open position

FIG. 2a is a partial enlarged cross-sectional view of the area encircled by line 2a of FIG. 2;

FIG. 3 is a partial cross-sectional side view of a portion of the poppet valve of FIG. 2 shown in the closed position;

FIG. 4 is an end view of the poppet valve as viewed from line 4-4 of FIG. 3;

FIG. 5 is a cross-sectional end view of the poppet valve taken along line 5-5 of FIG. 3;

FIG. 6 is an exploded perspective view of the poppet valve;

FIG. 7 is a close-up cross-sectional view of the poppet valve shown in the open position;

FIG. 7A is a cross-sectional view of a portion of the poppet valve taken along line 7A-7A of FIG. 7;

FIG. 7B is a cross-sectional view of a portion of the poppet valve taken along line 7B-7B of FIG. 7;

FIG. 8 is a perspective view of an exemplary cryogenic valve manifold employing the poppet valve; and

FIG. 9 is a plan view of an alternative cryogenic valve manifold employing the poppet valve.

### DETAILED DESCRIPTION

A poppet valve according to the invention allows media, such as liquid, gas, slurry, plasma, molten matter, solid matter in a suitable state or cryogenic fluid, to pass therethrough in one direction, such as when the pressure or flow of the media exceeds a certain value, yet prevents or reduces reverse flow, such as when the pressure or flow of the media falls below a certain value. The structure and components of the poppet valve is such that the valve may provide a relatively high service life and/or provide relatively high performance characteristics. To accomplish this, the poppet valve includes various features, each of which will be described in greater detail below, that may be employed singularly or in any suitable combination.

In one embodiment, the poppet valve includes a valve body and a poppet biased within the body. The poppet is biased, for example, with a spring. The poppet moves between an open position, in which forward flow is permitted, and a closed position, in which reverse flow is prevented or reduced.

According to one aspect of the invention, the poppet is held relative to the body in a manner that allows relative rotation of the poppet without causing undue rotation of the biasing spring. Such freedom of rotation of the poppet may reduce torsional stress on the spring, which may increase performance and/or service life of the valve.

According to another aspect of the invention, the poppet moves from the closed position to the open position over a predetermined stroke. This stroke may be sized such that the spring is not stressed beyond a tolerable amount, for example, to avoid full compression of the spring. In this manner, the spring may have a relatively high cycle life and/or high performance characteristics, thereby providing the poppet valve itself with a relatively high service life and/or relatively high performance characteristics.

According to yet another aspect of the invention, components of the poppet valve may be structured in a manner such that interference between cooperating components may be reduced. In this manner, wear or binding of valve components may be reduced, thereby increasing the service life and/or performance characteristics of the valve.

According to yet another aspect of the invention, components of the valve may be structured in a manner that increases the strength of the valve, again increasing the service life and/or performance characteristics of the valve.

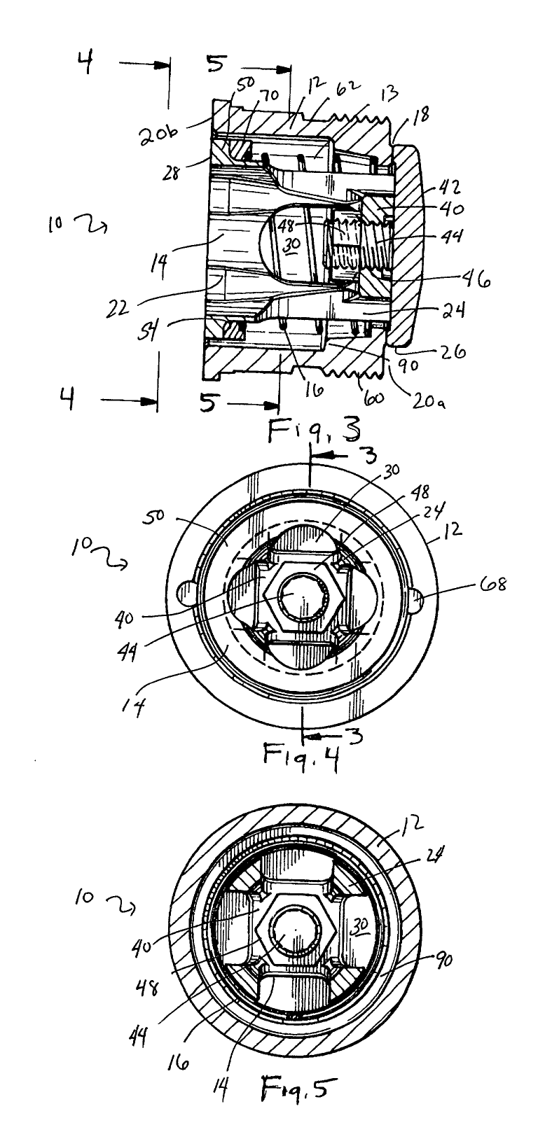

As discussed above, and with reference to FIGS. 1-7, the poppet valve 10 includes a generally cylindrical, hollow body 12 defining an inner cavity 13, a generally cylindrical poppet 14 having an axis 15 and a spring 16. The poppet 14 is disposed within the body 12 and is adapted to move axially between a closed position (shown in phantom lines in FIG. 1) and an open position (shown in solid lines in FIG. 1). The poppet valve 10 also includes a valve seat 18 defined by poppet seat surface 18a and body seat surface 18b on a downstream side 20a of the valve. When in the closed position, the surfaces 18a and 18b are in suitable contact so as to prevent or reduce reverse flow of media through the valve. When in the open position, surfaces 18a and 18b are spaced from each other by a suitable amount to permit flow of media through the value.

It should be appreciated that the valve may be employed to prevent, reduce or permit flow of any suitable form of media, such as, for example, liquid, gas, slurry, plasma, molten matter, solid matter in a suitable state, such as particulate matter, or cryogenic fluid as the present invention is not limited in this respect. As such, depending upon the media flowing through the poppet valve, it may be formed of any compatible material. In one example, the body and the poppet may be formed of brass or bronze.

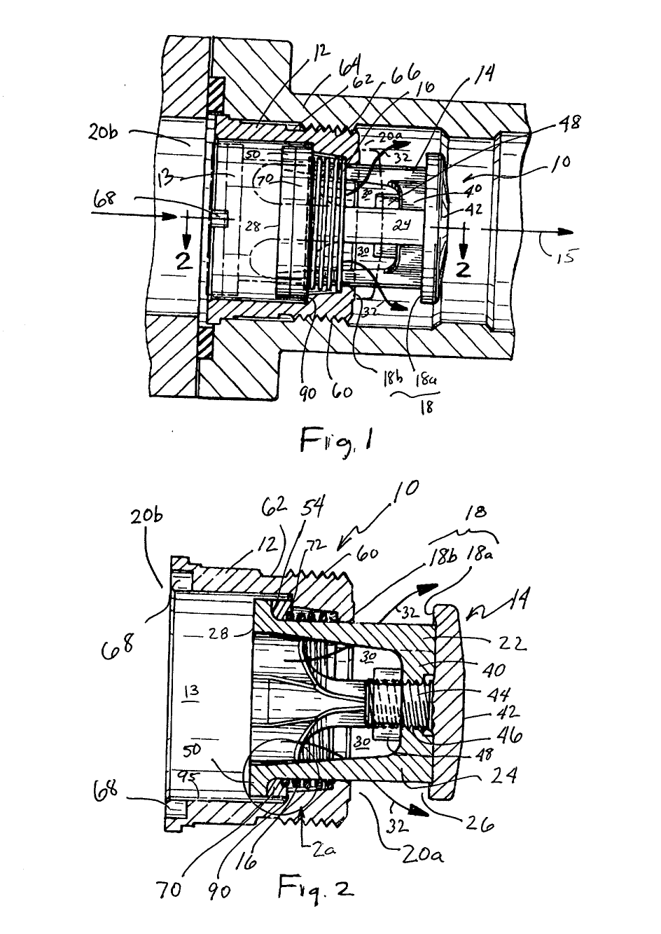

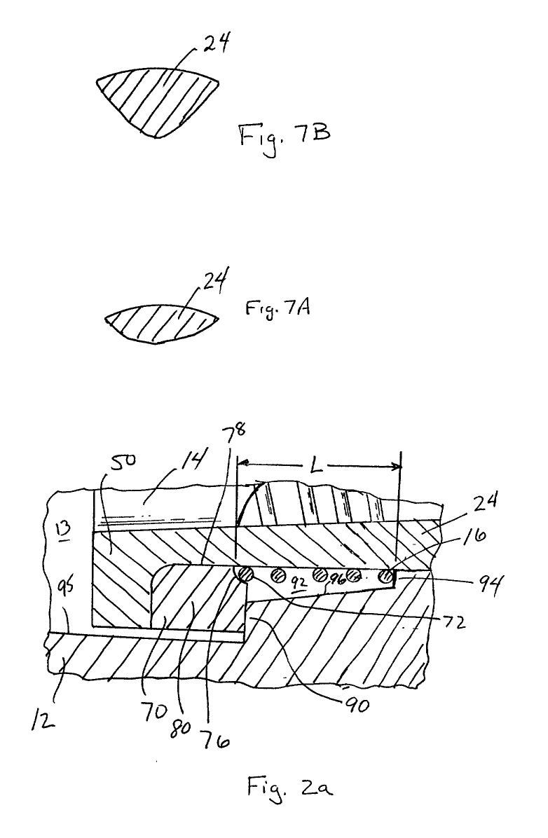

The poppet 14 may be biased toward the closed position such that, when flow through the valve is desired, the pressure of the media on an upstream side 20b of the valve must exceed the force of the spring 16 to open the poppet 14. In one embodiment, the spring 16 is a helical compression spring disposed within the body 12 and positioned between the body 12 and the poppet 14, as shown, for example in FIG. 2. The spring 16 may be formed of any suitable material, and preferably a material that is compatible with the media flowing through the valve 10.

It should be appreciated that although a helical compression spring is shown, the present invention is not limited in this respect. For example, the spring may be formed as a tension spring that acts to pull the poppet closed. Further, the poppet 14 may be biased using any suitable spring as the present invention is not limited to a helical spring. Examples of other such springs include, but are not limited to, Belleville washer springs, leaf springs, and torsion springs, to name a few. Also, the poppet 14 may be biased using any other suitable form of a spring, including elements formed of elastomeric materials. In addition, it should be appreciated that although the spring 16 is shown disposed between the poppet 14 and the body 12, other suitable locations, which may depend upon the type of spring used, may be employed.

The poppet 14 may be shaped in any suitable configuration to permit flow of media through the valve 10, as desired. In one embodiment, the poppet 14 includes a cage 22 that is defined by a plurality of longitudinally extending legs 24 (four legs in the example shown) spaced about the circumference of the cage 22 and extending between a downstream end 26 and an upstream end 28 of the poppet 14. The legs 24 may be integrally formed with the cage 22 or may be formed as separate elements subsequently joined as desired. The legs 24 are sufficiently spaced about the perimeter of the poppet 14, thereby defining a plurality of flow channels 30. The flow channels 30 are constructed and arranged to allow desired flow therethrough, as shown, for example, with flow arrows 32.

Although the channels 30 are formed between a plurality of legs 24, aspects of the present invention are not limited in this respect. For example, the poppet 14 may be formed with a central leg or column, rather than a series of legs spaced about the circumference. As such, the flow channel is defined by the space between the central column of the poppet and the inner surface of the body. Other suitable configurations for the poppet and the flow channels may be employed, as aspects of the present invention are not limited to any particular configuration.

At the downstream end 26 of the poppet 14, the legs join at a central boss 40. In one embodiment, a cap 42 is fastened to the boss 40 and includes the poppet seat surface 18a. To secure the cap 42 to the boss 40, and for ease of assembly, the cap 42 is formed with a threaded stud 44 and the boss 40 is formed with a threaded hole 46. The cap 42, therefore, can screw into the boss 40. A nut 48 may also be threaded onto the stud 44 extending beyond the boss 40 to further secure the cap 42 to the boss 40, as shown. The nut 48 may then be staked, welded or brazed to the stud 44 to prevent it from unscrewing while in service.

It is to be appreciated that although the poppet 14 includes a cap 42 that screws onto a boss 40, the present invention is not limited in this respect. For example, the cap may be integrally formed with the central boss or may be otherwise joined to the boss or to the legs in any desired manner, including: welding, brazing or other heat joining; adhesive bonding; riveting; heat shrinking; press fitting; or any other suitable method.

The poppet seat surface 18a of the cap 42 may be formed using any suitable technique including lathe turning, surface grinding, polishing, lapping etc. Seat surface 18b may be similarly formed. In this manner, a suitable seal may be formed at the valve seat 18 between surfaces 18a and 18b. It should be appreciated, however, that the present invention is not limited in this respect as other suitable sealing techniques may be employed. For example, an elastomeric or other suitable material may be disposed between the surfaces 18a and 18b. In addition, one or more elements formed of a material that is softer than that of either or both surfaces 18a and 18b may be employed and disposed between the surfaces. An example of such an element in an elastomeric seal known to those skilled in the art.

The legs 24 of the poppet 14 terminate at the upstream end 28 of the poppet. In one example, the legs 24 terminate at annular ring 50 of the poppet 14. The annular ring 50 is integrally formed with and extends radially outward from the legs 24 to define a shoulder 54. The shoulder 54 cooperates with the body 12 to limit the stroke of the poppet 14, as will be explained more fully below. It should be appreciated that although the legs 24 terminate at the annular ring 50, the present invention is not limited in this respect, as no annular ring need be provided. Also, the annular ring may be formed separately from the legs and subsequently joined to the legs.

To facilitate placement of the poppet valve 10 in a desired location within a process-related system, device or other desired structure, the body 12 of the poppet valve may be formed with threads 60 on its external surface 62. In this manner, as shown in FIG. 1, the body may be threaded into a pipe flanged 64 or other device or section of a device formed with mating threads 66. It should be appreciated that the poppet 14 may be fixed to a desired structure using any suitable means, as the present invention is not limited to the use of threads. For example, the poppet may be fixed using pipe clamps or other clamps or fastening devices. To facilitate insertion into the desired structure, in one embodiment, the body may be formed with a suitable tool surface. For example, as shown in FIGS. 1, 2, 4 and 6, at the upstream end 20b of the valve 10, the body 12 is formed with recesses 68 constructed to accept a tool, such as a spanner wrench. Of course, other suitable tools surfaces, such as slots for a screw driver, or flats for a box or hex wrench, may be employed.

As discussed briefly above, according to one aspect of the invention, the poppet 14 may be held in the body 12 in a manner that allows rotation of the poppet 14 relative to the spring 16 about the axis of the poppet 14, which may result in reduced torsional stress on the spring 16. In one embodiment, an interface element or decoupler, such as a slip ring 70, is disposed about the legs 24 of the poppet 14 and is seated adjacent the annular ring 50. The upstream end 72 of the spring 16 abuts the slip ring 70, as shown. The slip ring 70 is free to rotate relative to the poppet 14. In this manner, the spring is decoupled from the poppet such that should the spring 16 become bound to the slip ring 70 and/or the body 12, for example, by the ends of the spring 16 digging into the slip ring 70 and/or the body 12, the poppet 14 may freely rotate without also causing the spring 16 to also rotate. Allowing such freedom of movement reduces the likelihood that the spring will be subjected to a torsional force, which may otherwise cause undue stress and decreased cycle life and/or decreased performance.

In the embodiment described above, the slip ring 70 is able to freely rotate completely about the poppet 14. However, it is to be appreciated that the present invention is not limited in this respect. For example, the slip ring 70 may rotate through a limited arc. Further, although the slip ring 70 is not attached to the poppet in the embodiment shown such that it may move axially relative to the poppet, the slip ring 70 may be attached, yet may rotate through the use of suitable bearings or bearing assembly, for example. Other means of attachment and/or rotation will be recognized by those skilled in the art.

The slip ring 70 may be formed with a recess 76 (see FIG. 2a) or other such formation to receive at least a portion of the end 72 of the spring. In the embodiment shown, the recess 76 is formed on an inner edge 78 of the slip ring 70 such that the spring 16 is held between the body 80 of the slip ring 70 and the legs 24 of the poppet 14. However, the present invention is not limited in this respect, as the recess may be formed anywhere on the slip ring or no recess may be employed at all. In addition, other suitable means for receiving the spring may be employed. Further, the slip ring may be permanently or removably joined to the spring, as desired.

Also as discussed above, the poppet 14 moves axially within the body 12 over a predetermined stroke. According to another aspect of the invention, this stroke is sized so as to limit the stress on the spring 16 that may otherwise result from over compression. In one embodiment, the body 12 is formed with an abutment 90, such as an annular shoulder that acts as a stop and prevents the poppet from further travel in the open direction, as shown in FIGS. 2 and 2a. In the embodiment shown, the shoulder 90 bears upon the end of the slip ring 70 when the poppet 14 is in the fully opened position. However, if a slip ring is not employed, the shoulder would bear directly on the poppet.

In one embodiment, the shoulder is located on the body to define a cavity 92, which may be part of the cavity 13, within which the spring 16 may be received. In one embodiment, the length “L” of the resulting cavity is greater than the length of the spring when it is fully compressed. In this manner, the shoulder 90 prevents the poppet 14 from traveling a distance that would otherwise result in a fully compressed spring. In another embodiment, the position of the shoulder 90 may be such that the spring 16 is compressed only to a length that is greater than its fully compressed length, as shown. Thus, the feature of the shoulder 90 is to limit the amount of spring compression to a desired amount.

It should be appreciated however, that, as shown, the recess 76 in the slip ring 70 also forms part of the cavity 92 for the spring 16. However, as the present invention is not limited to the use of a recess, nor to the use of a slip ring, the length of the resulting cavity would be defined by the downstream inner wall surface 94 of the body 12 and the annular ring 50, if no slip ring 70 is provided, or would be defined by the downstream inner wall surface 94 of the body 12 and the end face of the slip ring 70, if no recess 76 is provided.

In the embodiment shown, the shoulder 90 or stop is integrally formed within the body 12. However, the present invention is not limited in this respect. For example, a stop may be formed as a ring that slips into or is secured within the body. In addition, although the stop may be shaped as a ring, the present invention is not limited in this respect. For example, a radial inwardly extending pin or pins, which may be fixed to the internal wall of the body, may be employed to limit the stroke of the poppet. Also, axially extending bars or pins formed in or inserted adjacent the internal wall may be employed. Other suitable means for limiting the travel of the poppet will be readily recognized by those skilled in the art, as the present invention is not limited to any particular form of a stop.

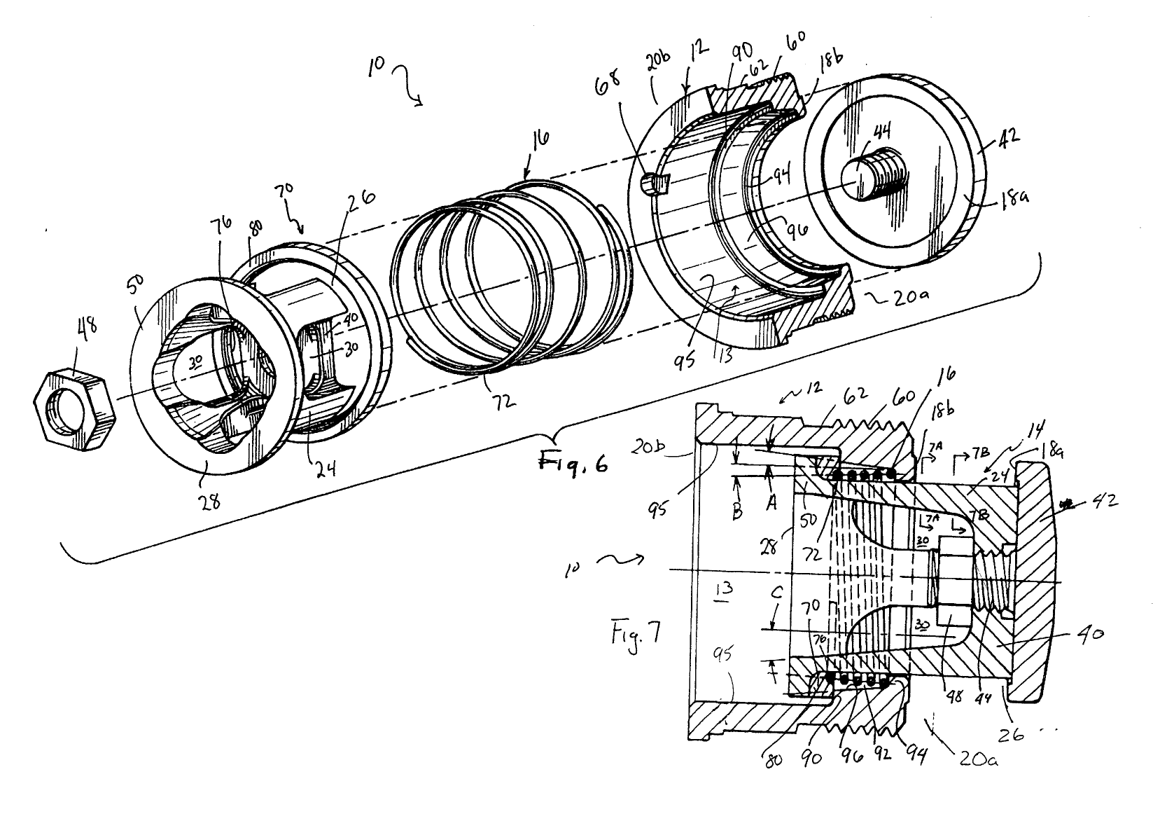

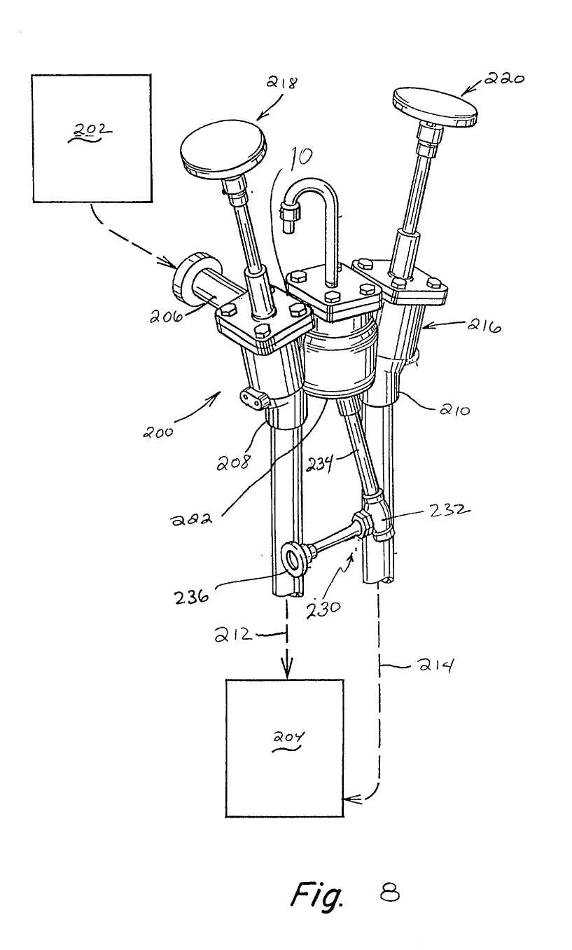

As discussed above, according to another aspect of the invention, the components of the poppet valve 10 may be structured in a manner such that interference between cooperating components may be reduced. In one embodiment, the interior wall 95 of the body cavity 13 may be tapered such that the spring 16 does not unduly interfere with the walls of the cavity. In one example, as shown best in FIGS. 2a and 7, at least a portion 96 of the interior wall 95 of the body cavity 13 is formed with taper, wherein the downstream end of the interior wall 95 of the body 12 is defined by a diameter that is smaller than the upstream end. In one embodiment, the angle “A” of the taper is about 5.42°, but may be greater or lesser, as desired. In addition, in one embodiment, the larger diameter of the inner wall 95 adjacent the shoulder 90 is about 1.41 inches.

In the embodiment shown, the taper is formed in the cavity defined by the downstream inner wall surface 94 of the body and the shoulder 90, that is, the cavity 92 within which the spring is received. However, the taper may extend for a greater or lesser distance along the interior wall 95, as desired. In addition, although the embodiment described includes a taper, the present invention is not limited in this respect. Accordingly, rather than forming a taper, the inner wall of the body or cavity may be formed with a series of steps, ramps or tapers, each one extending further out than an adjacent step or taper, thereby mimicking a tapered wall.

As discussed above, the stop used to limit the amount of compression of the spring 16 may be formed as a separate ring that slips into the body 12. In this embodiment, the inner wall of such a ring could also employ a taper such that the likelihood of the spring interfering with the inner wall of the stop ring would be reduced.

As a further measure of ensuring that the spring 16 does not substantially interfere with the inner wall 95 of the body 12, the spring 16 itself may also be tapered. In one embodiment, the spring 16 is tapered in an opposite direction to that of the taper of the inner wall of the body. In this respect, the smaller diameter of the spring 16 is positioned adjacent the slip ring 70, as best shown in FIGS. 2a and 7. In other words, the taper of the spring and the taper of the wall tend to converge toward each other at downstream end of the valve. The angle “B” of the spring taper may be the same angle as that of the inner wall or may be larger or smaller, as desired.

The use of a tapered coil spring may also provide additional benefits as may be apparent to those skilled in the art. For example, the spring may provide a centering action of the poppet 14 relative to the body 12. Furthermore, as the spring 16 is compressed, the major diameter of the spring 16 may grow. With the use of a tapered compression spring, the growth of the diameter of the spring 16 may be limited to a desired amount.

It is to be appreciated that, although a tapered spring may be employed, the present invention is not limited in this respect, as a straight sided spring may be employed. Furthermore, although a tapered inner wall of the body is shown and described, the present invention is not limited in this respect. Rather, a straight walled body may be employed.

Further, as discussed above, according to yet another aspect of the invention, various components of the poppet valve 10 may be structured in a manner that increases the strength of the valve. In this respect, at least one of the legs may have a cross-sectional area that changes along the longitudinal extent of the leg. In one embodiment, the legs 24 of the poppet 14 are tapered such that they have a cross sectional area that decreases in a direction from the downstream end (see FIG. 7b) of the poppet toward the upstream end (see FIG. 7a) of the poppet adjacent the slip ring. Such a configuration may maintain the desired flow through the valve while enhancing the structural integrity of the poppet. In one embodiment, the legs taper at an angle “C” (see FIG. 7) of approximately 6°, although a greater or lesser taper may be employed.

Such a configuration may result in a high strength to weight ratio. In this respect, this configuration may reduce fatigue on the poppet that may result from harmonics experienced in the valve or from a high duty cycle of the valve, while maintaining low valve weight.

Although tapered legs are shown and described, the present invention is not limited in this respect as other suitable configurations for the legs may be employed, such as a series of tapers, steps or ramps. Furthermore, not every leg of the poppet need be tapered as described. Rather one or more of the legs may be so tapered or each leg may be tapered at a different angle or may be otherwise configured differently, as the present invention is not limited in this respect.

Various combinations of the above-described embodiments can be employed together. However, the invention is not limited in this respect. Therefore, an aspect of the invention described above may be employed by itself, in other embodiments or with other aspects of the invention or combinations of other aspects of the invention.

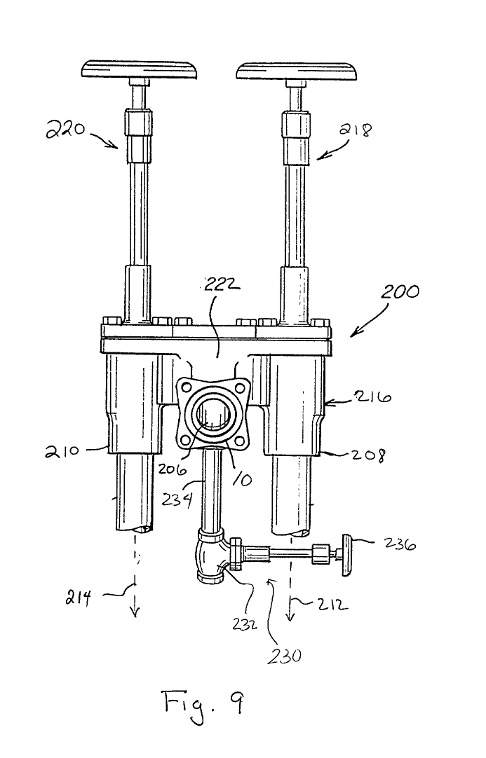

While the poppet valve may be employed in any number of process-related applications or devices, one particular application is an inlet check valve for a cryogenic valve manifold, which is used to control cryogenic fluid flow, as shown, for example, in FIGS. 8 and 9.

Valve manifold 200 may be fluidly coupled between a supply tank 202 and a storage tank 204 (see, for example, FIG. 8) as part of a fluid delivery system that transfers fluid from the supply tank 202 to the storage tank 204. The supply tank 202 is coupled to a single inlet 206 and the storage tank 204 is coupled to a pair of outlets 208, 210 which are fluidly coupled to the inlet 206 via internal valve chambers that divide the incoming fluid into separate feed lines. The valve manifold 200 advantageously divides the incoming fluid into separate feed lines 212, 214 to the storage tank, thereby reducing the complexity and increasing the reliability of the fluid delivery system. Additionally, the valve manifold 200 may prevent fluid in the storage tank 204 from inadvertently flowing back through the valve either into the supply tank 202 or out to the atmosphere. The valve manifold 200 may also filter undesirable debris from the fluid as it passes through the valve to reduce the risk of interfering with the operation of the valve itself or other equipment located downstream from the valve.

In one embodiment, the valve manifold 200 includes a housing 216, a pair of globe valve actuators 218, 220 for controlling fluid flow to the outlets 208, 210, poppet valve 10 disposed within inlet 206 for permitting forward flow through the manifold or preventing or reducing reverse flow through the manifold, and a filter (not shown) for restricting the size of debris that can pass through the manifold. The valve actuators 218, 220 are independently controllable so that the fluid flow to the outlets 212, 214 can be selectively adjusted. Although globe valve actuators are described herein, it should be understood that the present invention may be used with other valve types as would be apparent to one of skill in the art.

When fluid is pumped through the inlet 206, the pressure of the fluid causes the poppet valve 10 to open so that the fluid can enter the housing 216 for subsequent distribution through the outlets 208, 210. When fluid is no longer pumped through the manifold or the pressure at the inlet is no longer sufficient to sustain fluid flow through the poppet valve, the poppet 12 moves to the closed position, thereby closing poppet valve 10. The poppet 12 is forced tightly against the body by back pressure within the manifold housing 216 to seal the inlet 206 against reverse flow.

The manifold 200 may include a purge system 230 that can be used to remove collected debris from the inlet chamber. Additionally, the purge system 230 may be used to purge the fluid delivery system of atmospheric air immediately prior to the fluid transfer process to avoid contaminating the cryogenic fluid in the tank system. In one illustrative embodiment, the purge system 230 includes a purge valve 232 that is disposed at one end of a conduit 234 extending downwardly from the lower portion of the central manifold housing 222. The purge valve 232 is readily actuated by a stem and handle assembly 236.

The manifold 200 shown in FIG. 8 is constructed in a manner such that valve actuators 218, 220 are angled relative to each other. However, the cryogenic valve manifold may have parallel actuators 218, 220, wherein the actuators are axially aligned with a corresponding pair of parallel valve outlets 208, 210. An example of such a manifold is shown in FIG. 9. Other suitable manifolds or devices may be employed, as the present invention is not limited in this respect. In this respect, the valve manifolds described with reference to FIGS. 8 and 9 are merely exemplary.

Having described several embodiments of the invention in detail, various modifications and improvements will readily occur to those skilled in the art. Such modifications and improvements are intended to be within the spirit and scope of the invention. Accordingly, the foregoing description is by way of example only and is not intended as limiting. The invention is limited only as defined by the following claims and the equivalence thereto.

What is claimed is:

1. A poppet valve comprising:
a body;
a poppet having an axis and being disposed within the body and adapted to move axially between a closed position and an open position;
a spring cooperating with the poppet to bias the poppet toward the closed position; and
an interface element disposed between the poppet and the spring, the interface element facilitating rotation between the poppet and the spring about the axis of the poppet.

2. The poppet valve according to claim 1, wherein the interface element facilitates complete rotation between the poppet and the spring.

3. The poppet valve according to claim 1, wherein the interface element comprises a ring disposed about a portion of the poppet.

4. The poppet valve according to claim 3, wherein the ring comprises a recess adapted to receive at least a portion of the spring.

5. The poppet valve according to claim 1, wherein the spring is a tapered compression spring.

6. The poppet valve according to claim 1, further comprising an abutment cooperating with the poppet to limit the stroke of the poppet such that a resulting compressed length of the spring when the poppet is in a fully open position is greater than a fully compressed length of the spring.

7. The poppet valve according to claim 6, wherein the abutment comprises an annular surface.

8. The poppet valve according to claim 6, wherein the interface element is disposed on the poppet, and wherein the interface element engages the abutment when the poppet is in the fully open position.

9. The poppet valve according to claim 1, wherein the body has an inner wall defining a cavity, at least a portion of the wall being constructed and arranged to allow movement of the spring without substantial interference between the spring and at least the portion of the inner wall.

10. The poppet valve according to claim 9, wherein the portion of the wall is tapered.

11. The poppet valve according to claim 10, wherein the spring is a tapered compression spring, with the taper of the spring and the taper of the at least a portion of the wall tending to converge toward each other at a downstream end of the valve.

12. The poppet valve according to claim 1, wherein the poppet comprises at least one leg longitudinally extending between upstream and downstream ends of the valve, the at least one leg having a cross-sectional area that changes along the longitudinal extent of the at least one leg.

13. The poppet valve according to claim 12, wherein the at least one leg is tapered.

14. The poppet valve according to claim 13, wherein the cross-sectional area of the at least one leg at a location proximate the upstream end is smaller than the cross-sectional area of the at least one leg at a location proximate the downstream end.

15. The poppet valve according to claim 1, wherein the body is formed with external threads to facilitate securing the valve to a corresponding structure.

16. The poppet valve according to claim 1, wherein the body comprises a tool mating feature that is adapted to receive a tool to facilitate securing the valve to a corresponding structure.

17. The poppet valve according to claim 16, wherein the tool mating feature comprises a pair of recesses adapted to receive a spanner wrench.

18. The poppet valve according to claim 1, in combination with a cryogenic valve manifold, the poppet valve cooperating with the manifold to control flow therethrough.

19. A poppet valve comprising:
a body;
a poppet having an axis and being disposed within the body and adapted to move axially between a closed position and an open position, thereby defining a stroke;
a spring cooperating with the poppet to bias the poppet toward the closed position, the spring having a fully compressed length; and
an abutment cooperating with the poppet to limit the stroke of the poppet such that a resulting compressed length of the spring when the poppet is in a fully open position is greater than the fully compressed length of the spring.

20. The poppet valve according to claim 19, further comprising ring disposed between the poppet and the spring, the ring facilitating rotation between the poppet and the spring about the axis of the poppet.

21. The poppet valve according to claim 20, wherein the ring comprises a recess adapted to receive at least a portion of the spring.

22. The poppet valve according to claim 19, wherein the spring is a tapered compression spring.

23. The poppet valve according to claim 20, wherein the ring engages the abutment when the poppet is in a fully open position.

24. The poppet valve according to claim 19, wherein the body has an inner wall defining a cavity, at least a portion of the wall being constructed and arranged to allow movement of the spring without substantial interference between the spring and at least the portion of the inner wall.

25. The poppet valve according to claim 24, wherein the portion of the wall is tapered.

26. The poppet valve according to claim 25, wherein the spring is a tapered compression spring, with the taper of the spring and the taper of the portion of the wall tending to converge toward each other at a downstream end of the valve.

27. The poppet valve according to claim 19, wherein the poppet comprises at least one leg longitudinally extending between upstream and downstream ends of the valve, the at least one leg having a cross-sectional area that changes along the longitudinal extent of the at least one leg.

28. The poppet valve according to claim 27, wherein the at least one leg is tapered.

29. The poppet valve according to claim 28, wherein the cross-sectional area of the at least one leg at a location proximate the upstream end is smaller than the cross-sectional area of the at least one leg at a location proximate the downstream end.

30. The poppet valve according to claim 19, wherein the body is formed with external threads to facilitate securing the valve to a corresponding structure.

31. The poppet valve according to claim 19, wherein the body comprises a tool mating feature that is adapted to receive a tool to facilitate securing the valve to a corresponding structure.

32. The poppet valve according to claim 31, wherein the tool mating feature comprises a pair of recesses adapted to receive a spanner wrench.

33. The poppet valve according to claim 19, in combination with a cryogenic valve manifold, the poppet valve cooperating with the manifold to control flow therethrough.

34. A poppet valve comprising:
a body having an inner wall defining a cavity;
a poppet having an axis and being disposed within the cavity of the body and adapted to move axially between a closed position and an open position; and
a spring disposed within the cavity of the body and cooperating with the poppet to bias the poppet toward the closed position;
wherein at least a portion of the wall is constructed and arranged to allow movement of the spring without substantial interference between the spring and the portion of the inner wall.

35. The poppet valve according to claim 34, further comprising a ring disposed between the poppet and the spring, the ring facilitating rotation between the poppet and the spring about the axis of the poppet.

36. The poppet valve according to claim 35, wherein the ring comprises a recess adapted to receive at least a portion of the spring.

37. The poppet valve according to claim 34, wherein the spring is a tapered compression spring.

38. The poppet valve according to claim 35, wherein the body comprises an abutment engaging with the ring when the poppet is in a fully open position to limit the stroke of the poppet such that a resulting compressed length of the spring.

39. The poppet valve according to claim 34, wherein the portion of the wall is tapered.

40. The poppet valve according to claim 39, wherein the spring is a tapered compression spring, with the taper of the spring and the taper of the portion of the wall tending to converge toward each other at a downstream end of the valve.

41. The poppet valve according to claim 34, wherein the poppet comprises at least one leg longitudinally extending between upstream and downstream ends of the valve, the at least one leg having a cross-sectional area that changes along the longitudinal extent of the at least one leg.

42. The poppet valve according to claim 41, wherein the at least one leg is tapered.

43. The poppet valve according to claim 41, wherein the cross-sectional area of the at least one leg at a location proximate the upstream end is smaller than the cross-sectional area of the at least one leg at a location proximate the downstream end.

44. The poppet valve according to claim 34, wherein the body is formed with external threads to facilitate securing the valve to a corresponding structure.

45. The poppet valve according to claim 34, wherein the body comprises a tool mating feature that is adapted to receive a tool to facilitate securing the valve to a corresponding structure.

46. The poppet valve according to claim 45, wherein the tool mating feature comprises a pair of recesses adapted to receive a spanner wrench.

47. The poppet valve according to claim 34, in combination with a cryogenic valve manifold, the poppet valve cooperating with the manifold to control flow therethrough.

48. A poppet valve comprising:
a body defining an upstream end and a downstream end;
a poppet having an axis and being disposed within the body and adapted to move axially between a closed position and an open position, the poppet comprising at least one leg longitudinally extending between the upstream and downstream ends of the body, the at least one leg having a cross-sectional area that changes along the longitudinal extent of the at least one leg.

49. The poppet valve according to claim 48, further comprising a spring cooperating with the poppet to bias the poppet toward the closed position.

50. The poppet valve according to claim 49, further comprising a ring disposed about the at least one leg and between the poppet and the spring, the ring facilitating rotation between the poppet and the spring about the axis of the poppet.

51. The poppet valve according to claim 50, wherein the ring comprises a recess adapted to receive at least a portion of the spring.

52. The poppet valve according to claim 49, wherein the spring is a tapered compression spring.

53. The poppet valve according to claim 50, wherein the body comprises an abutment engaging with the ring when the poppet is in a fully open position to limit the stroke of the poppet such that a resulting compressed length of the spring.

54. The poppet valve according to claim 49, wherein the body has an inner wall defining a cavity, at least a portion of the wall being tapered to allow movement of the spring without substantial interference between the spring and at least the portion of the inner wall.

55. The poppet valve according to claim 54, wherein the spring is a tapered compression spring, with the taper of the spring and the taper of the at least a portion of the wall tending to converge toward each other at a downstream end of the valve.

56. The poppet valve according to claim 48, wherein the at least one leg is tapered.

57. The poppet valve according to claim 48, wherein the cross-sectional area of the at least one leg at a location proximate the upstream end is smaller than the cross-sectional area of the at least one leg at a location proximate the downstream end.

58. The poppet valve according to claim 48, wherein the body is formed with external threads to facilitate securing the valve to a corresponding structure.

59. The poppet valve according to claim 48, wherein the body comprises a tool mating feature that is adapted to receive a tool to facilitate securing the valve to a corresponding structure.

60. The poppet valve according to claim 59, wherein the tool mating feature comprises a pair of recesses adapted to receive a spanner wrench.

61. The poppet valve according to claim 48, in combination with a cryogenic valve manifold, the poppet valve cooperating with the manifold to control flow therethrough.

62. A poppet valve comprising:
a body defining an upstream end and a downstream end, the body having an inner wall defining a cavity;
a poppet having an axis and being disposed within the cavity of the body and adapted to move axially between a closed position and an open position, thereby defining a stroke, the poppet comprising at least one leg longitudinally extending between the upstream and downstream ends of the body, the at least one leg having a cross-sectional area that changes along the longitudinal extent of the at least one leg;
a spring disposed within the cavity of the body and cooperating with the poppet to bias the poppet toward the closed position, the spring having a fully compressed length, at least a portion of the inner wall of the body is constructed and arranged to allow movement of the spring without substantial interference between the spring and the portion of the inner wall;
a ring disposed on the poppet and cooperating with the spring, the ring facilitating rotation between the poppet and the spring about the axis of the poppet; and
an abutment engaging with the ring to limit the stroke of the poppet such that a resulting compressed length of the spring when the poppet is in a fully open position is greater than the fully compressed length of the spring.

63. The poppet valve according to claim 62, wherein the ring comprises a recess adapted to receive at least a portion of the spring.

64. The poppet valve according to claim 62, wherein the portion of the inner wall is tapered and wherein the spring is a tapered compression spring, with the taper of the spring and the taper of the portion of the wall tending to converge toward each other at a downstream end of the valve.
